(19) United States
(12) Patent Application Publication
(10) Pub. No.: US 2004/0079852 A1
(43) Pub. Date: Apr. 29, 2004

(54) Mirror holder combination apparatus

(76) Inventors: Yin-Chun Huang, Hsin-Chu City (TW); Chien-Liang Yeh, Hsin-Chu City (TW)

Correspondence Address: Nath & Associates, PLLC, Sixth Floor, 1030 15th Street, N.W., Washington, DC, 20005, US

(21) Appl. No.: 10/390,601

(22) Filed: Mar. 19, 2003

(30) Foreign Application Priority Data
Oct. 25, 2002 (TW) 091124948

(51) Int. Cl. B60R 1/02; A47F 1/14; A47G 1/16

(52) U.S. Cl. 248/466

(57) ABSTRACT

The present invention discloses a mirror holder for holding a mirror. The mirror holder comprises a mirror protection wall for bearing the backside of the mirror, a sidewall extending from the protection wall to contact one side of the mirror longitudinal, and a fastener for fastening the mirror. A mirror holder combination apparatus comprises a mirror holder and a mirror. The mirror holder comprises a mirror protection wall for bearing the backside of the mirror, a sidewall extending from the protection wall to contact one longitudinal side of the mirror, a fastener for fastening the front of the mirror, and a chassis for loading and fastening the mirror holder. A method for mirror assembling comprises forming a interconnecting plurality of mirror holders, bearing the backside of the mirror on protection wall of the mirror holder, fastening the mirror, cutting the plurality of mirror holders and mirrors to form a plurality of discrete mirror holders with mirror, and loading and fastening the discrete mirror holder on a chassis.

### BACKGROUND OF THE PRESENT INVENTION

1. Field of the Present Invention:

The present invention relates to a mirror holder combination, and more particularly, to a mirror holder combination applied in a scanner.

2. Description of the Prior Art:

A scanner is an apparatus that converts static image into digital image, the three major kinds of which including hand-held scanner, sheet-fed scanner, and flatbed scanner. A hand-held scanner is product of lower class in early days, reading images by manually moving the scanner. The features of which are low spatial demand and low price. However, this kind is scarcely used in the present day since it has fewer dot per inch (DPI) and the scanning effect is poorer. A sheet-fed scanner resembles a simply constructed fax in its appearance, and its price and DPI are between those of a hand-held scanner and those of a flatbed scanner. The flatbed scanner is the mainstream product in the market at present, having high scanning quality and the DPI of which reaching 1200 DPI (1200 dots per inch) or even above. DPI means pixels in a unit square area and indicating the resolution. The scanner of higher DPI is also available for medical scanning or precise identification, such as film scanner and large-format scanner specially designed for printing and press industry that read images at high speed and on large scale.

Besides, the functioning principle of scanner is: first, drive motor driving blaze tube through drive belt, blaze being illuminated on a picture, and after the light being reflected, the light being transmitted to sensitization elements on Charge Coupling Device (CCD) through a set of mirrors. (In prior scanner, the scanning has to be processed for three times to analyze the three colors red, blue, and green at each time, but present scanner is able to analyze the three colors at the same time. However, specialized image scanner at present still scans for three times, one color at each time.) When the scanning process starts, sensitization elements on CCD are like sensitization cells in human eyes, converting light beams of different intensities to electric currents of different intensities, analog signals of which are then converted to digital signals that can be read by computer through ADC. The digital signals are transmitted to the screen through connecting wires of computer, and then the image of picture is showed on the screen.

According the above-mentioned, the light beams are transmitted to sensitization elements on CCD through a set of mirrors after the light is reflected, the mirrors said above including a reflected mirror. And when a reflected mirror used at present is thicker, 2 mm thick, for example, it is easy to bend if placed improperly since the mirror has a larger length. And generally speaking, the width of mirror is also larger than its thickness. Therefore, it is easy for the mirror to shake when it is cut. Thus it is necessary to fasten the mirror.

According to the above-mentioned reasons, a mirror holder combination apparatus for fastening the mirror and facilitate cutting and transporting of the mirror is being eagerly searched.

### SUMMARY OF THE INVENTION

One purpose of the present invention is to provide a mirror holder, said mirror holder being able to hold the mirror.

Another purpose of the present invention is to provide a mirror holder combination for facilitating the cutting of the mirror after it is held by the mirror holder. With said mirror holder, the mirror can be protected from being snapped, and thickness and width of the mirror can be reduced.

Still another purpose of the present invention is to provide a method for combining the mirror, discrete mirror holder being able to loaded and fastened on a chassis with said combining method.

The present invention discloses a mirror holder for holding a mirror, said mirror holder comprising: a mirror protection wall for bearing the backside of the mirror; a sidewall extending from the protection wall and contacting one longitudinal side of the mirror; and, a fastener for fastening the mirror.

The present invention discloses a mirror holder combination apparatus, comprising: a mirror; and a mirror holder. Said mirror holder comprises: a mirror protection wall for bearing the backside of the mirror; a sidewall extending from the protection wall and contacting one longitudinal side of the mirror; a fastener for fastening the front of the mirror; and a chassis for loading and fastening the mirror holder.

The present invention discloses a method for combining mirror, said method comprising: forming a interconnecting plurality of mirror holders; loading the backside of a mirror on protection wall of the mirror holder; fastening the mirror; cutting the plurality of mirror holders and mirrors to form a plurality of discrete mirror holders with mirror; and, loading and fastening the discrete mirror holder on a chassis.

### BRIEF DESCRIPTION OF THE DRAWINGS:

More detailed description of the preferred embodiments of the present invention will be presented in the following text supported by the following drawings.

FIG. 1 is a diagram of discrete mirror holder of the present invention loaded and fastened on a chassis;

FIG. 2 is a diagram of mirror holder of the present invention;

FIG. 3 is a top-view of mirror holder combination apparatus of the present invention;

FIG. 4 is a top-view of mirror holder combination apparatus of the present invention;

FIG. 5 is a diagram of mirror holder of the present invention.

### DESCRIPTION OF THE PREFERRED EMBODIMENT

The present invention discloses a method for combining mirror holder, mirror holder combination apparatus, and mirror. Detailed description is as follows, the preferred embodiment described in the following being only for description and not for confining the present invention.

The present invention discloses a mirror holder for holding a mirror, said mirror holder comprising: a mirror protection wall for bearing the backside of the mirror; a sidewall extending from the protection wall and contacting one longitudinal side of the mirror; and, a fastener for fastening the mirror. A mirror holder combination apparatus, comprising: a mirror; a mirror holder. Said mirror holder comprises: a mirror protection wall for bearing the backside of the mirror; a sidewall extending from the protection wall and contacting one longitudinal side of the mirror; a fastener for fastening the front of the mirror; and, a chassis for loading and fastening the mirror holder.

A method for combining mirror, said method comprising: forming a interconnecting plurality of mirror holders; loading the backside of a mirror on mirror protection wall of the mirror holder; fastening the mirror; cutting the plurality of mirror holders and mirrors to form a plurality of discrete mirror holders with mirror; and, loading and fastening the discrete mirror holder on a chassis.

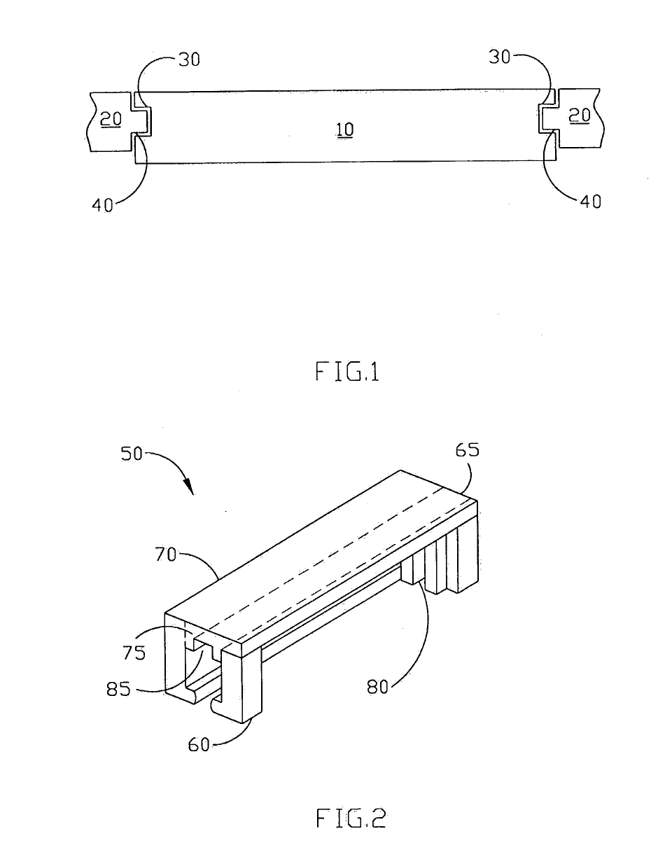

FIG. 1 is a diagram of said discrete mirror holder loaded and fastened on a chassis. Mirror holder 10 is an apparatus holding mirror, having sink 30. Chassis 20 is an apparatus on which mirror holder 10 is loaded, having protrusion 40, and carrier 20 being combined tightly to sink 30 with its protrusion 40 for trough-fastening mirror holder 10. And, mirror holder 10 can also be screw-fastened by chassis 20 with a screw. Mirror holder combination apparatus said above can be applied in some parts of a scanner.

FIG. 2 is a diagram of mirror holder of the present invention. What is shown in FIG. 2 is an embodiment of mirror holder of the present invention, function of mirror holder 50 being to protect the mirror from snapping and to reduce damage to mirror caused by external force or collision. The materials of mirror holder 50 include: fiber-glass and all kinds of plastics (including engineering plastics). And the shape of mirror holder 50 changes according to the shape of mirror. Mirror holder 50 can be formed by injection molding method. The mirror holder 50 has a fastener, a mirror protection wall 70, and a sidewall 65, the fastener including a protruding clip 60 that is close to another longitudinal side of mirror for fastening the front of mirror. The mirror protection wall 70 is made in indented and protruded form on the surface on which mirror is loaded for the mirror to attach close onto the protection wall 70; and, a trough 80 is set inside the sidewall 65 for trough-fastening longitudinal side of the mirror. The trough 80 can be a [symbol] -type sink, for example. The mirror is placed in [symbol] -type sink 80 and clipped by clip 60 and mirror protection wall 70. The depth of [symbol] -type sink 80 is set for easy placement of mirror, and the width of it is about the same as the thickness of mirror or larger. When the mirror holder 50 clips the mirror that is to be placed, the mirror can be cut into shape that is needed. The thickness of mirror is 1 mm. The mirror holder 50 further includes a top-wall 75, extending from mirror protection wall 70 and being perpendicular respectively to sidewall 70 and sidewall 65; a trough 85 is set inside the top-wall 75 for trough-fastening the transversal side of mirror.

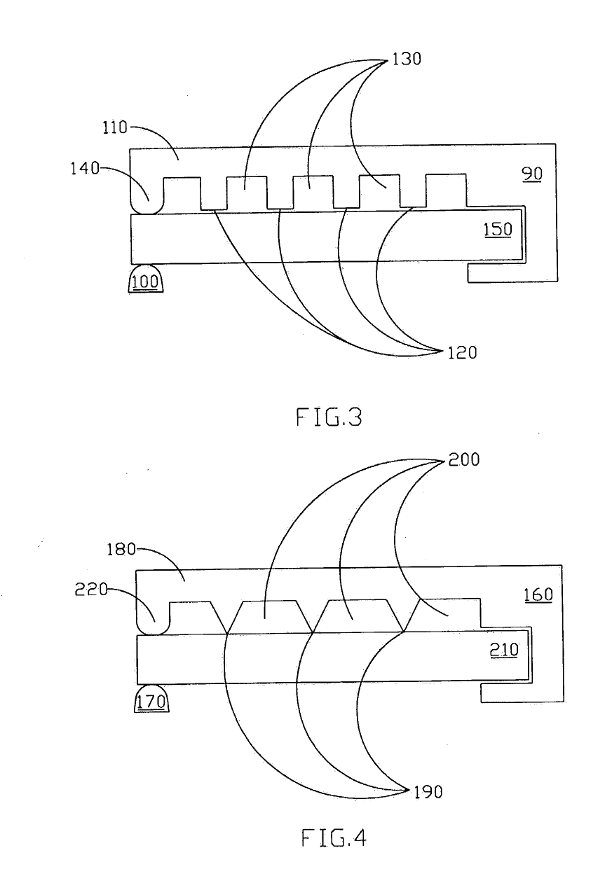

FIG. 3 is a top-view of the mirror holder combination apparatus in FIG. 2. There is a clip 100 in the front part of mirror holder 90 and the rear part of mirror holder 90 is a mirror protection wall 110, the front part of which is a plurality of oblong protrusion 120 to make the mirror attach close onto the mirror protection wall 110, interval between the plurality of protrusion 120 being sink 130. The mirror 150 is placed in [symbol] -type sink on base, which can be clipped by clip 100 and protrusion 140 on the mirror protection wall 110. The depth of [symbol] -type sink is set for easy placement of the mirror 150, and the width of it is about the same as the thickness of mirror 150 or larger. When the mirror holder 90 clips the mirror 150 that is to be placed, the mirror 150 can be cut into shape that is needed. The thickness of mirror 150 is 1 mm.

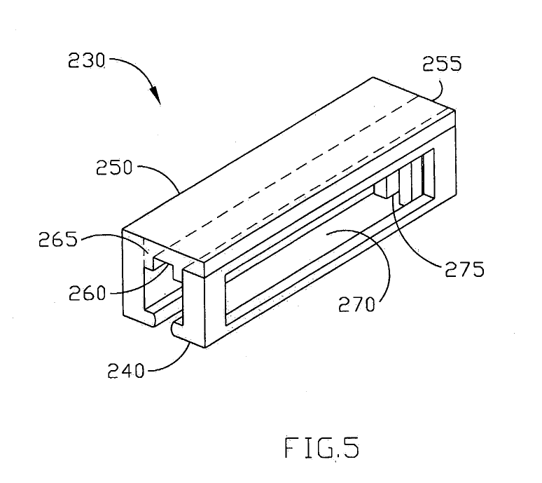

FIG. 4 is a top-view of another mirror holder combination apparatus in FIG. 2, which is another embodiment of the present invention. There is a clip 170 in the front part of mirror holder 160 and the rear part of mirror holder 160 is a mirror protection wall 180, the front part of which is a plurality of triangular protrusion 190 to make the mirror attach close onto the mirror protection wall 180, interval between the plurality of triangular protrusion 190 being sink 200. The mirror 210 is placed in [symbol] -type sink on base, which can be clipped by clip 170 and protrusion 220 on the mirror protection wall 180. The depth of [symbol] -type sink is set for easy placement of the mirror 210, and the width of it is about the same as the thickness of mirror 210 or larger. When the mirror holder 160 clips the mirror 210 that is to be placed, the mirror 210 can be cut into shape that is needed. The thickness of mirror 210 is 1 mm.

FIG. 5 is a diagram of mirror holder of the present invention. What is shown in FIG. 5 is another embodiment of mirror holder of the present invention, function of mirror holder 230 being to protect the mirror from snapping and to reduce damage to mirror caused by external force or collision. The materials of mirror holder 230 include: fiber-glass and all kinds of plastics (including engineering plastics). And the shape of mirror holder 230 changes according to the shape of mirror. Mirror holder 230 can be formed by injection molding method. The mirror holder 230 has a fastener, a mirror protection wall 250, and a sidewall 255, the fastener including a protruding clip 240 that is close to another longitudinal side of mirror for fastening the front of mirror. The mirror protection wall 250 is made in indented and protruded form on the surface on which mirror is loaded for the mirror to attach close onto the protection wall 250; and, a trough 275 is set inside the sidewall 255 for trough-fastening longitudinal side of the mirror. The trough 275 can be a [symbol] -type sink, for example. The mirror is placed in [symbol] -type sink 275 and clipped by clip 240 and mirror protection wall 250. The depth of [symbol] -type sink 275 is set for easy placement of mirror, and the width of it is about the same as the thickness of mirror or larger. When the mirror holder 230 clips the mirror that is to be placed, the mirror can be cut into shape that is needed. The thickness of mirror is 1 mm. The mirror holder 230 further includes a top-wall 265, extending from mirror protection wall 250 and being perpendicular respectively to mirror protection wall 250 and sidewall 255; a trough 260 is set inside the top-wall 265 for trough-fastening the transversal side of mirror. And the mirror holder 230 further includes a window frame 270, perpendicular respectively to sidewall 255 and top-wall 265, light beams projecting on the surface of the mirror through the frame-hole of window frame 270.

One feature of the present invention is to provide a mirror holder combination apparatus to fasten the mirror for mirror cutting process afterwards. When there is collision caused by improper external force, the mirror can be protected from snapping with the mirror holder said above. Therefore, with protection of the mirror holder, thickness and width of the mirror can both be reduced.

For those who are skilled in the art, although the present invention is illustrated with one preferred embodiment, the spirit of the present invention is not confined. Modifications and similar arrangements made within the spirit and scope disclosed by the present invention should be included in the appended claims, which should be in accordance with the broadest interpretation that covers all modifications and similar structures. Therefore, the preferred embodiment of the present invention described above can be used to differentiate all modifications made within the spirit and scope of the present invention.

What is claimed is:

1. A mirror holder, for fastening a mirror, said mirror holder comprising:
a mirror protection wall, for bearing the backside of the mirror;
a sidewall, extending from said mirror protection wall and contacting one longitudinal side of said mirror; and
a fastener, for fastening said mirror.

2. The mirror holder of claim 1, wherein said mirror protection wall is made in sunk and protruded form on the surface on which mirror is loaded.

3. The mirror holder of claim 1, wherein a trough is set inside said sidewall for trough-fastening longitudinal side of said mirror.

4. The mirror holder of claim 1, wherein said fastener includes a protruded clip close to another longitudinal side of said mirror for fastening the front of said mirror.

5. The mirror holder of claim 1, wherein said mirror holder further includes a top-wall extending from said mirror protection wall and being perpendicular respectively to said mirror protection wall and said sidewall.

6. The mirror holder of claim 5, wherein a trough is set inside said top-wall for trough-fastening a transversal side of said mirror.

7. The mirror holder of claim 5, wherein said mirror holder further includes a window frame perpendicular respectively to said sidewall and said top-wall, light beams projecting on the surface of said mirror through frame-hole of said window frame.

8. The mirror holder of claim 1, wherein materials of said include: fiber-glass or plastics including engineering plastics.

9. The mirror holder of claim 1, wherein thickness of said mirror is 1 mm.

10. A mirror holder combination apparatus, comprising:
a mirror;
a mirror holder, comprising:
a mirror protection wall for bearing the backside of the mirror;
a sidewall, extending from said mirror protection wall and contacting one longitudinal side of said mirror;
a fastener, for fastening front of said mirror; and
a chassis, for loading and fastening said mirror holder.

11. The mirror holder combination apparatus of claim 10, wherein said mirror protection wall is made in sunk and protruded form on the surface on which mirror is loaded.

12. The mirror holder combination apparatus of claim 10, wherein a trough is set inside said sidewall for trough-fastening longitudinal side of said mirror.

13. The mirror holder combination apparatus of claim 10, wherein said fastener includes a protruded clip close to another longitudinal side of said mirror for fastening the front of said mirror.

14. The mirror holder combination apparatus of claim 10, wherein said mirror holder further includes a top-wall extending from said mirror protection wall and being perpendicular respectively to said mirror protection wall and said sidewall.

15. The mirror holder combination apparatus of claim 14, wherein a trough is set inside said top-wall for trough-fastening a transversal side of said mirror.

16. The mirror holder combination apparatus of claim 14, wherein said mirror holder further includes a window frame perpendicular respectively to said sidewall and said top-wall, light beams projecting on the surface of said mirror through frame-hole of said window frame.

17. The mirror holder combination apparatus of claim 10, wherein materials of said include: fiber-glass or plastics including engineering plastics.

18. The mirror holder combination apparatus of claim 10, wherein thickness of said mirror is 1 mm.

19. The mirror holder combination apparatus of claim 10, wherein said chassis is fastened with said mirror holder by trough-fastening method or screw-fastening method.

20. A method for combining mirror, comprising:
forming a interconnecting plurality of mirror holders;
loading the backside of a mirror on mirror protection wall of the mirror holder;
fastening said mirror;
cutting said plurality of mirror holders and mirrors to form a plurality of discrete mirror holders with mirror; and
loading and fastening said discrete mirror holder on a chassis.

21. The method for combining mirror of claim 20, wherein forming a sidewall is further included, said sidewall extending from said mirror protection wall and contacting one longitudinal side of said mirror.

22. The method for combining mirror of claim 21, wherein a trough is set inside said sidewall for trough-fastening longitudinal side of said mirror.

23. The method for combining mirror of claim 20, wherein forming said mirror protection wall into indented and protruded form on the surface on which said mirror is loaded.

24. The method for combining mirror of claim 20, wherein the fastening of said mirror is completed by fastening front of said mirror with a protruded clip close to another longitudinal side of said mirror.

25. The method for combining mirror of claim 21, wherein forming a top-wall is further included, said top-wall extending from said mirror protection wall and being perpendicular respectively to said mirror protection wall and said sidewall.

26. The method for combining mirror of claim 25, wherein setting a trough inside said top-wall is further included for trough-fastening a transversal side of said mirror.

27. The method for combining mirror of claim 25, wherein forming a window frame is further included, said window frame being perpendicular respectively to said sidewall and said top-wall and light beams projecting on surface of said mirror through frame-hole of said window frame.
